(19) United States
(12) Patent Application Publication
(10) Pub. No.: US 2015/0294432 A1
(43) Pub. Date: Oct. 15, 2015

(54) GESTURE-BASED NOTIFICATION

(71) Applicant: Bank Of America Corporation, Charlotte, NC (US)

(72) Inventors: Alicia C. Jones, Fort Mill, SC (US); Richard Andrew Starbuck, Walnut Creek, CA (US); David M. Grigg, Rock Hill, SC (US)

(73) Assignee: BANK OF AMERICA CORPORATION, Charlotte, NC (US)

(21) Appl. No.: 14/251,071

(22) Filed: Apr. 11, 2014

(51) Int. Cl. G06Q 50/26; G06F 17/30; G06F 3/01

(52) U.S. Cl. CPC G06Q 50/265; G06F 3/017; G06F 17/30864

(57) ABSTRACT

Systems, methods, and computer program products for use by a financial institution employee in a financial institution environment to determine a preferred level of service based on gesture recognition. Embodiments of the invention involve a memory device; and a processing device operatively coupled to a memory; a computing processor; and a module configured to cause the one or more computing processors to: receive from a first device, an input associated with one or more gestures from an employee in a business environment; compare the received input to one or more predetermined gestures stored in a database, wherein the one or more predetermined gestures stored in the database are associated with one or more actions; based on the comparison, determine a match, and execute the one or more actions associated the received input.

### FIELD

In general, embodiments of the invention relate to generating notification based on gesture recognition to initiate the execution of an action.

### BACKGROUND

Gesture recognition, in general, is defined in computer science and language technology as the interpretation of human gestures via mathematical algorithms. Over the past few years, gesture recognition has become a commonplace technology in the gaming and entertainment markets enabling humans and machines to interface more easily. Among a variety of gestures, hand gesture is the most expressive and the most frequently used. This kind of human-machine interfaces would allow a customer to control a wide variety of devices through hand gestures. With the advent of wearable technology, the integration of gesture recognition in multiple forms with wearable devices are being investigated and researched. Typically, a wearable technology includes devices that are accessories incorporating computer and advanced electronic technologies. In general, wearable technology is related to the field of ubiquitous computing, sharing the vision of interweaving technology into everyday life and making technology pervasive and interaction frictionless.

In today's business environments, the use of wearable technology integrated with gesture recognition will enable a customer to provide seamless customer service interaction without any mechanical device and improve the customer's overall experience with the business. Therefore, a need exists to develop methods, apparatus, and computer program products for use by a customer service representative in a business environment (e.g., financial institution environment) to determine a preferred level of service based on gesture recognition. Further, the desired methods, apparatus, and computer program products should leverage the advantages provided by the integration of wearable technology and gesture recognition to assist in determining a preferred level of service.

### BRIEF SUMMARY

Embodiments of the present invention address the above needs and/or achieve other advantages by providing apparatuses (e.g., a system, computer program product, and/or other device) and methods for use by a financial institution employee in a financial institution environment to determine a preferred level of service based on gesture recognition.

Embodiments of the invention include systems, computer program products, and methods for use by a financial institution employee in a financial institution environment to determine a preferred level of service based on gesture recognition. Specific embodiments of the invention comprises a wearable apparatus for use by a financial institution employee in a financial institution environment to determine a preferred level of service based on gesture recognition, the apparatus comprising: a memory; a computing processor; and a module stored in memory, said module comprising instruction code executable by one or more computing processors, and configured to cause the one or more computing processors to receive from a first device, an input associated with one or more gestures from an employee in a business environment, wherein the one or more gestures are based on at least a recognition of a customer in the business environment by the employee. In response, compare the received input to one or more predetermined gestures stored in a database, wherein the one or more predetermined gestures stored in the database are associated with one or more actions. Based on the comparison, determine a match between the received input and the one or more predetermined gestures stored in the database and in response to determining the match, execute the one or more actions associated the received input.

In some embodiments, the module is further configured to determine that the received input indicates that the customer is associated with one or more potential security issues.

In some embodiments, the module is configured to initiate the execution of one or more security protocols associated with the one or more potential security issues.

In some embodiments, the one or more security protocols are associated with one or more levels, wherein the one or more levels are based on the severity of the potential security issue.

In some embodiments, the module is further configured to determine that the received input indicates that the customer is a preferred customer.

In some embodiments, determining that the customer is a preferred customer is based on at least an asset balance of the customer, wherein the asset balance is an aggregation of one or more account balances associated with one or more financial institution accounts of the customer.

In some embodiments, the one or more actions further comprises compiling one or more documents associated with the customer, wherein the one or more documents are associated with one or more financial institution processes, wherein the one or more financial institution processes are associated with the customer, wherein the customer is a financial institution customer.

In some embodiments, the one or more actions include transmitting an alert, wherein transmitting an alert further comprises transmitting an alert to a second employee.

In some embodiments, the module is further configured to enable the second employee to receive the alert, determine one or more actions associated with the alert and in response, initiate an execution of the one or more actions associated with the alert.

In some embodiments, the module is configured to receive the alert in the form of a text message, a pop up notification, an email, or on a display monitor.

In some embodiments, the alert is based on at least determining that the customer is not a financial institution customer or determining that the customer is a financial institution customer, wherein determining that the customer is not a financial institution customer comprises determining whether the customer is a potential security issue, wherein determining that the customer is a financial institution customer further comprises determining an asset balance associated with the customer.

In one aspect, a method for use by a financial institution employee in a financial institution environment to determine a preferred level of service based on gesture recognition, the method comprising: receiving, using a computing device processor, from a first device, an input associated with one or more gestures from an employee in a business environment, wherein the one or more gestures are based on at least a recognition of a customer in the business environment by the employee. In response, comparing, using a computing device processor, the received input to one or more predetermined gestures stored in a database, wherein the one or more predetermined gestures stored in the database are associated with one or more actions and based on the comparison, determining, using a computing device processor, a match between the received input and the one or more predetermined gestures stored in the database. In response to determine the match, executing, using a computing device processor, the one or more actions associated the received input.

In some embodiments, determining further comprises determining that the received input indicates that the customer is associated with one or more potential security issues.

In some embodiments, determining further comprises determining that the received input indicates that the customer is a preferred customer.

In some embodiments, determining that the customer is a preferred customer is based on at least an asset balance of the customer, wherein the asset balance is an aggregation of one or more account balances associated with one or more financial institution accounts of the customer.

In some embodiments, the executing the one or more actions further comprises compiling one or more documents associated with the customer, wherein the one or more documents are associated with one or more financial institution processes, wherein the one or more financial institution processes are associated with the customer, wherein the customer is a financial institution customer.

In some embodiments, executing the one or more actions include transmitting an alert, wherein transmitting an alert further comprises transmitting an alert to a second employee.

In some embodiments, transmitting the alert further comprises enabling the second employee to receive the alert, determine one or more actions associated with the alert, and initiate an execution of the one or more actions associated with the alert.

In some embodiments, the alert is based on at least determining that the customer is not a financial institution customer or determining that the customer is a financial institution customer, wherein determining that the customer is not a financial institution customer comprises determining whether the customer is a potential security issue, wherein determining that the customer is a financial institution customer further comprises determining an asset balance associated with the customer.

In another aspect, a computing program product for use by a financial institution employee in a financial institution environment to determine a preferred level of service based on gesture recognition, the computer program product comprising a non-transitory computer-readable medium comprising code causing a first apparatus to receive from a first device, an input associated with one or more gestures from an employee in a business environment, wherein the one or more gestures are based on at least a recognition of a customer in the business environment by the employee. In response, compare the received input to one or more predetermined gestures stored in a database, wherein the one or more predetermined gestures stored in the database are associated with one or more actions. Based on the comparison, determine a match between the received input and the one or more predetermined gestures stored in the database and in response to determining the match, execute the one or more actions associated the received input.

### BRIEF DESCRIPTION OF THE DRAWINGS

Having thus described embodiments of the invention in general terms, reference will now be made to the accompanying drawings, where:

FIG. 1 presents high level process flow for use by a financial institution employee in a financial institution environment to determine a preferred level of service based on gesture recognition, in accordance with embodiments of the present invention.

FIG. 2 illustrates a first customer interface for initiating an execution of one or more actions associated with the alert, in accordance with embodiments of the present invention.

FIG. 3 illustrates an exemplary block diagram of the system environment, in accordance with embodiments of the present invention.

### DETAILED DESCRIPTION OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a customer to establish an account with the entity. An “account” may be the relationship that the customer has with the entity. Examples of accounts include a deposit account, such as a transactional account (e.g. a banking account), a savings account, an investment account, a money market account, a time deposit, a demand deposit, a pre-paid account, a credit account, a non-monetary customer profile that includes only personal information associated with the customer, or the like. The account is associated with and/or maintained by an entity. In other embodiments, an “entity” may not be a financial institution.

In some embodiments, a “customer” may be a financial institution employee (e.g., an underwriter, a project manager, an IT specialist, a manager, an administrator, an internal operations analyst, bank teller or the like) capable of operating the system for providing a gesture based notification. In some other embodiments, a customer may be an employee in any business environment. For purposes of this invention, the term “customer” and “employee” may be used interchangeably. In some embodiments, a “customer” may be a financial institution customer (e.g., an account holder or a person who have an account (e.g., banking account, credit account, or the like)). In one aspect, a customer may be any individual who enters a financial institution environment. In some embodiments, the customer may be an individual who may be interested in opening an account with the financial institution. In some other embodiments, a customer may be any individual who enters a business environment.

In some embodiments, one or more employees in the business environment may be equipped with a computing device capable of receiving one or more gestures. In some other embodiments, the business environment itself may be equipped with a security system including one or more computing devices capable of receiving one or more gestures from the employee. In one aspect, the computing device may include a smart device capable of capturing an image and/or video stream. In another aspect, the computing device may include a wearable device (such as a smart computer) capable of receiving one or more gestures from the employee (e.g., a smart camera mounted on an optical head mounted display). In yet another aspect, the computing device may be a wearable device including one or more accelerometers/gyroscopes capable of receiving one or more gestures in the form of acceleration inputs. In yet another aspect, the computing device may include a mobile computer (e.g., tablet computer, graphics tablet, or the like) with a multi-touch surface capable of recognizing inputs related to one or more swipe gestures.

In some embodiments, the computing device may include one or more gesture recognition protocols capable of processing the one or more gestures received from an employee. In one aspect, the computing device may be a part of the security system in a business environment mounted in an elevated position relative to position of the employee, or any position with a clear line of sight to the employee. In such cases, the employee may perform a gesture that may be captured by the computing device in the security system as an image and/or video stream. In some other embodiments, the computing device may be mounted on an optical head mounted display (OHMD) capable of being worn by an employee and be configured to receive one or more gestures. In such cases, the employee may perform a gesture in the field of view of the smart camera mounted on the OHMD. In yet another embodiment, the computing device may capture one or more gestures in the form of acceleration data from the one or more accelerometers/gyroscopes in the computing device. In such cases, the customer may perform a gesture capable of being recorded by the computing device based on acceleration. In yet another aspect, the wearable device may be any smart device capable of processing hand gestures.

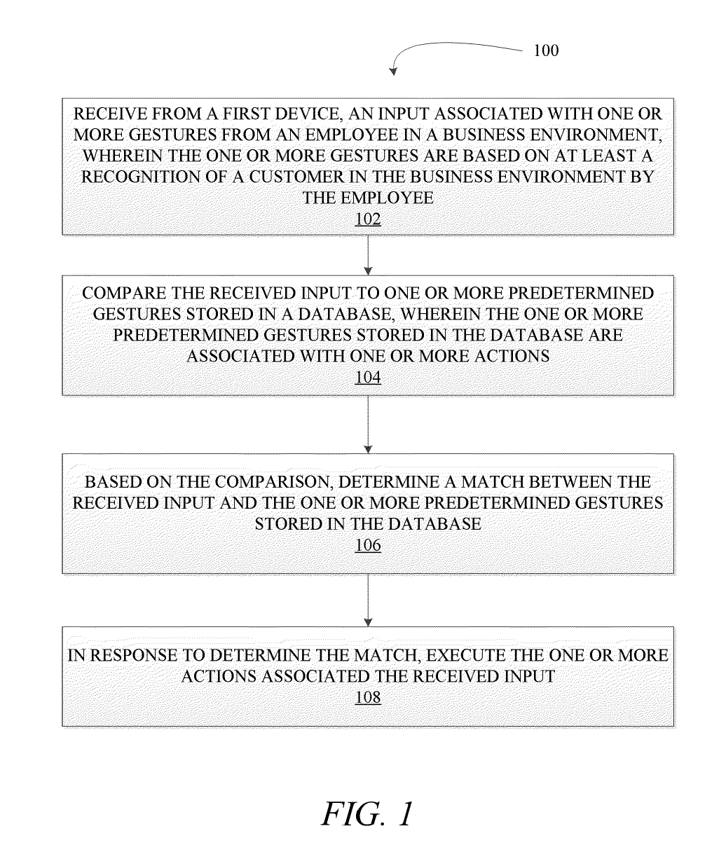

FIG. 1 presents a high level process flow for providing a gesture based notification, in accordance with one embodiment of the invention 100. In some embodiments, the system may enable the employee to identify a customer entering a financial institution environment for a service. As shown in block 102, the system may be configured to receive from a first device, an input associated with one or more gestures from an employee in a business environment, wherein the one or more gestures are based on at least a recognition of a customer in the business environment by the employee. For example, an employee in a financial institution environment may recognize that a customer has entered the financial institution environment (e.g., a bank). The computing device associated with the employee may capture an image of the customer as the customer enters the financial institution environment and determine that the customer is a preferred customer. In response, the customer may initiate one or more gestures based on determining that the customer is a preferred customer.

In some embodiments, each gesture initiated by the employee is in response to identifying a one or more events occurring in the financial institution environment. For example, an event may include a preferred customer entering the financial institution, an individual's actions recognized as a potential security issue, or the like. In one embodiment, the one or more predetermined gestures may be based on the customer being associated with the financial institution. In some embodiments, the one or more predetermined gestures may be based on the customer not being associated with the financial institution. In one aspect, determining that the customer is not associated with the financial institution includes determining whether the customer may be a potential new customer. In another aspect, determining that the customer is not associated with the financial institution includes determining whether the customer may be potential security issue.

In some embodiments, the gestures may include a specific hand gesture. In some other embodiments, the gestures may include a sequence of two of more gestures. For example, a smart camera associated with the security system may recognize an employee's “hands-up” gesture in case of a security threat. In another example, the smart camera associated with the employee's OHMD may recognize a specific set of hand gestures in response to identifying a preferred customer entering the financial institution environment. In yet another example, a processing device may recognize the employee's actions (e.g., lateral hand motion, waving finger, or the like) based on the wearable accelerometer based device. In one aspect, the input may include a combination of one or more gestures. In some embodiments, the customer input may include hand gesture from only one hand. In another embodiment, the customer input may include hand gestures made by a combination of both hands.

In response to receiving the customer input, the process may compare the received input to one or more predetermined gestures stored in a database, wherein the one or more predetermined gestures stored in the database are associated with one or more actions, as shown in block 104. In some embodiments, the comparing the received input to the one or more predetermined gestures further includes extracting one or more features associated with the received input. In one aspect, the one or more features may be extracted based on one or more image processing techniques capable of being applied to the received input. In another aspect, the one or more features may be extracted based on the acceleration data points. In yet another aspect, the one or more features may be extracted from the real-time video stream as captured by the smart camera associated with the security system/wearable OHMD.

In response to comparing the received input to one or more predetermined gestures stored in the database, the process includes determining a match between the received input and the one or more predetermined gestures stored in the database, as shown in block 106. For example, if the employee identifies that a customer is entering a financial institution environment and identifies that the customer is a preferred customer, the predetermined gesture as initiated by the employee can be compared with one or more predetermined gestures in the database to determine a match. In some embodiments, determining a match may include determining one or more actions associated with the predetermined gestures. In one aspect, the one or more actions may be associated with one or more service levels. In some embodiments, the one or more service levels may be based on an asset balance associated with the identified customer. In one aspect, the asset balance of a financial institution customer may be an aggregation of one or more financial institution account balances associated with the customer. For example, a customer is a preferred customer if the asset balance is above $10,000. In another example, the customer is a preferred customer if the customer is involved in a loan/mortgage process with the financial institution.

In response to determining a match, the process flow includes executing one or more actions associated with the received input, as shown in block 108. In some embodiments, the one or more actions may include transmitting an alert. The generation of the alert may include retrieving one or more customer information from the customer's financial institution account. For example, once the customer is identified to be a preferred customer, the generated alert may include an asset balance, an image of the customer as captured by the wearable device and/or the customer image as stored in the financial institution database, or the like.

In some embodiments, the one or more actions further includes compiling one or more documents associated with the customer. The one or more documents compiled may be associated with one or more financial institution processes (e.g., opening an account, loan/mortgage process, or the like). For example, the customer entering the financial institution may be associated with the financial institution in the loan/mortgage process, and the customer's visit to the financial institution environment may be to submit additional collateral documents to advance the loan/mortgage process. In such scenarios, the one or more actions may include preparing one or more documents beforehand in an attempt to save customer wait time and serve the customers more efficiently.

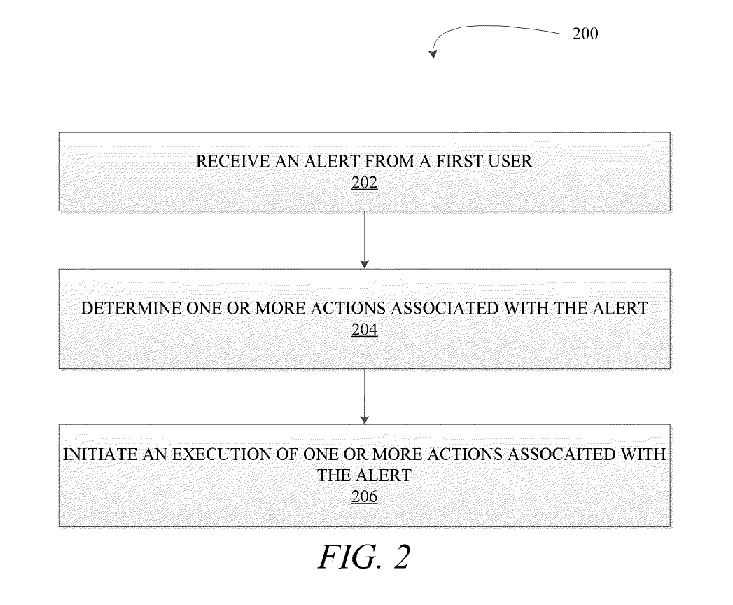

FIG. 2 presents a process flow for initiating an execution of one or more actions associated with the alert 200. In some embodiments, the apparatus may be configured to enable the second employee to receive the alert, as shown in block 202. In one aspect, the alert may be received in the form of a text message, a pop up notification, an email, or on a display monitor. In some embodiments, the alert may be based on at least determining that the customer is not a financial institution customer. In response to determining that the customer is not associated with the financial institution, the apparatus may be configured to determine whether the customer is a potential security issue. In some other embodiments, in response to determining that the customer is not associated with the financial institution and that the customer is not a potential security issue, the system may be configured to determine that the customer may be a potential new customer.

In response to receiving the alert, the system may be configured to determine one or more actions associated with the alert, as shown in block 204. In response to determining one or more actions associated with the alert, the apparatus may be configured to initiate an execution of the one or more actions associated with the alert, as shown in block 206. In one aspect, in response to determining that the customer may be potential security issue, the apparatus may be configured to initiate the execution of one or more security protocols associated with the one or more potential security issues. In one aspect, the one or more security protocols are associated with one or more levels. In some embodiments, the one or more levels are based on the severity of the potential security issue. In some other embodiments, determining that the customer is not a financial institution customer and that the customer is not a potential security issue comprises initiating the execution of one or more services associated with a potential new financial institution customer process. For example, the second employee, in response to receiving a notification regarding a potential new customer may gather the relevant paperwork and provide a more efficient service to the customer and begin the process of opening an account without having the customer wait in a queue. In another example, the second employee, in response to receiving an alert regarding a potential security issue, may notify the security personnel and/or other employees within the financial institution environment, or if need be, notify the authorities of a security issue to initiate adequate action more efficiently.

In some embodiments, the alert further comprises information associated with the customer. In one aspect, the information associated with the customer comprises at least one of a customer's image as captured by the module, a notification indicating whether the customer is associated with the financial institution, an asset balance associated with the customer if the customer is associated with the financial institution, a notification indicating that the customer is not associated with the financial institution and that the customer is not a potential security issue, or a notification indicating whether the customer is not associated with the financial institution and that the customer is associated with one or more potential security issues.

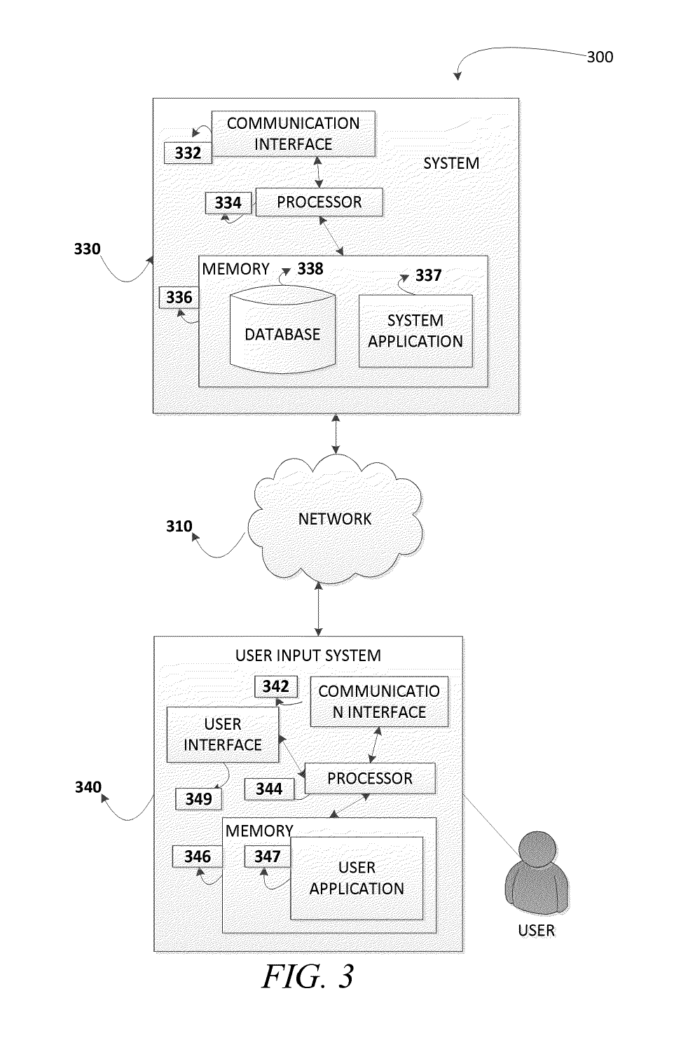

FIG. 3 presents an exemplary block diagram of the system environment 300 for implementing the process flows described herein in accordance with embodiments of the present invention. As illustrated, the system environment 300 includes a network 310, a system 330, and a customer input system 340. Also shown in FIG. 3 is a customer of the customer input system 340. The customer input system 340 may be a mobile device or other non-mobile computing device. The customer may be a person who uses the customer input system 340 to execute a customer application 347. The customer application 347 may be an application to communicate with the system 330, perform a transaction, input information onto a customer interface presented on the customer input system 340, or the like. The customer application 347 and/or the system application 337 may incorporate one or more parts of any process flow described herein.

As shown in FIG. 3, the system 330, and the customer input system 340 are each operatively and selectively connected to the network 310, which may include one or more separate networks. In addition, the network 310 may include a telecommunication network, local area network (LAN), a wide area network (WAN), and/or a global area network (GAN), such as the Internet. It will also be understood that the network 310 may be secure and/or unsecure and may also include wireless and/or wired and/or optical interconnection technology.

The customer input system 340 may include any computerized apparatus that can be configured to perform any one or more of the functions of the customer input system 340 described and/or contemplated herein. For example, the customer may use the customer input system 340 to transmit and/or receive information or commands to and from the system 330. In some embodiments, for example, the customer input system 340 may include a personal computer system (e.g. a non-mobile or non-portable computing system, or the like), a mobile computing device, a personal digital assistant, a mobile phone, a tablet computing device, a network device, and/or the like. As illustrated in FIG. 3, in accordance with some embodiments of the present invention, the customer input system 340 includes a communication interface 342, a processor 344, a memory 346 having an customer application 347 stored therein, and a customer interface 349. In such embodiments, the communication interface 342 is operatively and selectively connected to the processor 344, which is operatively and selectively connected to the customer interface 349 and the memory 346. In some embodiments, the customer may use the customer application 347 to execute processes described with respect to the process flows described herein. Specifically, the customer application 347 executes the process flows described herein.

Each communication interface described herein, including the communication interface 342, generally includes hardware, and, in some instances, software, that enables the customer input system 340, to transport, send, receive, and/or otherwise communicate information to and/or from the communication interface of one or more other systems on the network 310. For example, the communication interface 342 of the customer input system 340 may include a wireless transceiver, modem, server, electrical connection, and/or other electronic device that operatively connects the customer input system 340 to another system such as the system 330. The wireless transceiver may include a radio circuit to enable wireless transmission and reception of information. Additionally, the customer input system 340 may include a positioning system. The positioning system (e.g. a global positioning system (GPS), a network address (IP address) positioning system, a positioning system based on the nearest cell tower location, or the like) may enable at least the customer input system 340 or an external server or computing device in communication with the customer input system 340 to determine the location (e.g. location coordinates) of the customer input system 340.

Each processor described herein, including the processor 344, generally includes circuitry for implementing the audio, visual, and/or logic functions of the customer input system 340. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the customer application 347 of the memory 346 of the customer input system 340.

Each memory device described herein, including the memory 346 for storing the customer application 347 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 3, the memory 346 includes the customer application 347. In some embodiments, the customer application 347 includes an interface for communicating with, navigating, controlling, configuring, and/or using the customer input system 340. In some embodiments, the customer application 347 includes computer-executable program code portions for instructing the processor 344 to perform one or more of the functions of the customer application 347 described and/or contemplated herein. In some embodiments, the customer application 347 may include and/or use one or more network and/or system communication protocols.

Also shown in FIG. 3 is the customer interface 349. In some embodiments, the customer interface 349 includes one or more output devices, such as a display and/or speaker, for presenting information to the customer. In some embodiments, the customer interface 349 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the customer. In some embodiments, the customer interface 349 includes the input and display devices of a mobile device, which are operable to receive and display information.

FIG. 3 also illustrates a system 330, in accordance with an embodiment of the present invention. The system 330 may refer to the “apparatus” described herein. The system 330 may include any computerized apparatus that can be configured to perform any one or more of the functions of the system 330 described and/or contemplated herein. In accordance with some embodiments, for example, the system 330 may include a computer network, an engine, a platform, a server, a database system, a front end system, a back end system, a personal computer system, and/or the like. Therefore, the system 330 may be a server managed by the entity. The system 330 may be located at the facility associated with the entity or remotely from the facility associated with the entity. In some embodiments, such as the one illustrated in FIG. 3, the system 330 includes a communication interface 332, a processor 334, and a memory 336, which includes a system application 337 and a structured database 338 stored therein. As shown, the communication interface 332 is operatively and selectively connected to the processor 334, which is operatively and selectively connected to the memory 336.

It will be understood that the system application 337 may be configured to implement any one or more portions of the various customer interfaces and/or process flow described herein. The system application 337 may interact with the customer application 347. It will also be understood that, in some embodiments, the memory includes other applications. It will also be understood that, in some embodiments, the system application 337 is configured to communicate with the structured database 338, the customer input system 340, or the like.

It will be further understood that, in some embodiments, the system application 337 includes computer-executable program code portions for instructing the processor 334 to perform any one or more of the functions of the system application 337 described and/or contemplated herein. In some embodiments, the system application 337 may include and/or use one or more network and/or system communication protocols.

In addition to the system application 337, the memory 336 also includes the structured database 338. As used herein, the structured database 338 may be one or more distinct and/or remote databases. In some embodiments, the structured database 338 is not located within the system and is instead located remotely from the system. In some embodiments, the structured database 338 stores information or data described herein.

It will be understood that the structured database 338 may include any one or more storage devices, including, but not limited to, datastores, databases, and/or any of the other storage devices typically associated with a computer system. It will also be understood that the structured database 338 may store information in any known way, such as, for example, by using one or more computer codes and/or languages, alphanumeric character strings, data sets, figures, tables, charts, links, documents, and/or the like. Further, in some embodiments, the structured database 338 may include information associated with one or more applications, such as, for example, the system application 337. It will also be understood that, in some embodiments, the structured database 338 provides a substantially real-time representation of the information stored therein, so that, for example, when the processor 334 accesses the structured database 338, the information stored therein is current or substantially current.

It will be understood that the embodiment of the system environment illustrated in FIG. 3 is exemplary and that other embodiments may vary. As another example, in some embodiments, the system 330 includes more, less, or different components. As another example, in some embodiments, some or all of the portions of the system environment 300 may be combined into a single portion. Likewise, in some embodiments, some or all of the portions of the system 330 may be separated into two or more distinct portions.

In addition, the various portions of the system environment 300 may be maintained for and/or by the same or separate parties. It will also be understood that the system 330 may include and/or implement any embodiment of the present invention described and/or contemplated herein. For example, in some embodiments, the system 330 is configured to implement any one or more of the embodiments of the process flows described and/or contemplated herein in connection any process flow described herein. Additionally, the system 330 or the customer input system 340 is configured to initiate presentation of any of the customer interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for providing a gesture based notification, the system comprising:
a computing platform including one or more computing processors, a memory in communication with the processor, and configured to receive one or more gestures;
a module stored in the memory, said module comprising instruction code executable by one or more computing processors, and configured to cause the one or more computing processors to:
receive from a first device, an input associated with one or more gestures from an employee in a business environment, wherein the one or more gestures are based on at least a recognition of a customer in the business environment by the employee;
compare the received input to one or more predetermined gestures stored in a database, wherein the one or more predetermined gestures stored in the database are associated with one or more actions;
based on the comparison, determine a match between the received input and the one or more predetermined gestures stored in the database;
in response to determine the match, execute the one or more actions associated the received input.

2. The system of claim 1, wherein the module is further configured to determine that the received input indicates that the customer is associated with one or more potential security issues.

3. The system of claim 2, wherein the module is configured to initiate the execution of one or more security protocols associated with the one or more potential security issues.

4. The system of claim 2, wherein the one or more security protocols are associated with one or more levels, wherein the one or more levels are based on the severity of the potential security issue.

5. The system of claim 1, wherein the module is further configured to determine that the received input indicates that the customer is a preferred customer.

6. The system of claim 5, wherein determining that the customer is a preferred customer is based on at least an asset balance of the customer, wherein the asset balance is an aggregation of one or more account balances associated with one or more financial institution accounts of the customer.

7. The system of claim 1, wherein the one or more actions further comprises compiling one or more documents associated with the customer, wherein the one or more documents are associated with one or more financial institution processes, wherein the one or more financial institution processes are associated with the customer, wherein the customer is a financial institution customer.

8. The system of claim 1, wherein the one or more actions include transmitting an alert, wherein transmitting an alert further comprises transmitting an alert to a second employee.

9. The system of claim 8, wherein the module is further configured to enable the second employee to:
receive the alert;
determine one or more actions associated with the alert; and
initiate an execution of the one or more actions associated with the alert.

10. The system of claim 9, wherein the module is configured to receive the alert in the form of a text message, a pop up notification, an email, or on a display monitor.

11. The system of claim 9, wherein the alert is based on at least determining that the customer is not a financial institution customer or determining that the customer is a financial institution customer, wherein determining that the customer is not a financial institution customer comprises determining whether the customer is a potential security issue, wherein determining that the customer is a financial institution customer further comprises determining an asset balance associated with the customer.

12. A method for use by a financial institution employee in a financial institution environment to determine a preferred level of service based on gesture recognition, the method comprising:
receiving, using a computing device processor, from a first device, an input associated with one or more gestures from an employee in a business environment, wherein the one or more gestures are based on at least a recognition of a customer in the business environment by the employee;
comparing, using a computing device processor, the received input to one or more predetermined gestures stored in a database, wherein the one or more predetermined gestures stored in the database are associated with one or more actions;
based on the comparison, determining, using a computing device processor, a match between the received input and the one or more predetermined gestures stored in the database;
in response to determine the match, executing, using a computing device processor, the one or more actions associated the received input.

13. The method of claim 12, wherein determining further comprises determining that the received input indicates that the customer is associated with one or more potential security issues.

14. The method of claim 12, wherein determining further comprises determining that the received input indicates that the customer is a preferred customer.

15. The method of claim 14, wherein determining that the customer is a preferred customer is based on at least an asset balance of the customer, wherein the asset balance is an aggregation of one or more account balances associated with one or more financial institution accounts of the customer.

16. The method of claim 12, wherein the executing the one or more actions further comprises compiling one or more documents associated with the customer, wherein the one or more documents are associated with one or more financial institution processes, wherein the one or more financial institution processes are associated with the customer, wherein the customer is a financial institution customer.

17. The method of claim 12, wherein executing the one or more actions include transmitting an alert, wherein transmitting an alert further comprises transmitting an alert to a second employee.

18. The method of claim 17, wherein transmitting the alert further comprises enabling the second employee to:
receive the alert;
determine one or more actions associated with the alert; and
initiate an execution of the one or more actions associated with the alert.

19. The method of claim 17, wherein the alert is based on at least determining that the customer is not a financial institution customer or determining that the customer is a financial institution customer, wherein determining that the customer is not a financial institution customer comprises determining whether the customer is a potential security issue, wherein determining that the customer is a financial institution customer further comprises determining an asset balance associated with the customer.

20. A computing program product for use by a financial institution employee in a financial institution environment to determine a preferred level of service based on gesture recognition, the computer program product comprising a non-transitory computer-readable medium comprising code causing a first apparatus to:
receive from a first device, an input associated with one or more gestures from an employee in a business environment, wherein the one or more gestures are based on at least a recognition of a customer in the business environment by the employee;
compare the received input to one or more predetermined gestures stored in a database, wherein the one or more predetermined gestures stored in the database are associated with one or more actions;
based on the comparison, determine a match between the received input and the one or more predetermined gestures stored in the database;
in response to determine the match, execute the one or more actions associated the received input.
